(19) United States
(12) Patent Application Publication
(10) Pub. No.: US 2008/0016192 A1
(43) Pub. Date: Jan. 17, 2008

(54) System and Method for Performing an Administrative Task upon the Occurrence of a Triggering Event

(75) Inventors: Bryan Frederick Smith, Austin, TX (US); Peter Wansch, San Jose, CA (US)

Correspondence Address: GATES & COOPER LLP, 6701 CENTER DRIVE WEST, SUITE 1050, LOS ANGELES, CA, 90045, US

(73) Assignee: INTERNATIONAL BUSINESS MACHINES CORPORATION, Armonk, NY (US)

(21) Appl. No.: 11/457,310

(22) Filed: Jul. 13, 2006

(51) Int. Cl. G06F 15/173

(52) U.S. Cl. 709/223

(57) ABSTRACT

In response to a triggering event, a resilient administrative schedule system recognizes a need to perform an administrative task on one of a set of data servers. A user selects the administrative task. The system determines an operational status of the data server to determine a communication protocol for communicating with the data server, selects the communication protocol based on the operational status of the data server adding the selected administrative task to a task list, and automatically executes the selected administrative task at a predetermined execution time without intervention by a human administrator.

### FIELD OF THE INVENTION

The present invention generally relates to administration of tasks on computational systems comprising computers with possibly dissimilar operating systems. More particularly, the present invention pertains to a user remotely initiating administrative tasks on computers in a distributed computing system.

### BACKGROUND OF THE INVENTION

Data servers comprise the enterprise information tier in an enterprise application. These data servers typically run on systems and operating systems that are separate and different from the other enterprise application tiers. A typical enterprise application comprises a client tier, a mid-tier and an enterprise information tier. Each of these tiers comprises computational resources that often utilize different operating systems. For example, an enterprise application may comprise a data server operating on a mainframe using an operating system such as z/OS®; the mid-tier may comprise application servers operating on UNIX, and the client tier may, for example, comprise Web browsers on PCs using Windows® operating system.

Data servers can require complex administrative tasks to be executed by an administrator who logs on to the server on which the data server runs. Complex administrative tasks comprise, for example, system recovery, homogenous system copy, database creation, scale-out. In addition, automated administrative tasks including collecting statistics, backing up databases, reorganizing database containers or transforming data for text indexing, data analysis, system monitoring) are typically automated by an administrator using an operating system-specific scheduler.

Complex and automated administrative tasks require the administrator to have operating system-specific knowledge to perform these tasks. This requirement for specific knowledge to execute administrative tasks on the operating system or to run operating system-specific agents or facilities to perform these administrative tasks often presents a need for additional personnel trained to perform these administrative tasks, resulting in a higher total cost of ownership for the enterprise application and the data server in particular. The labor cost for administrators of enterprise applications represents a significant and increasing share of a typical enterprise information technology budget, while the prices for hardware, software, and services, continue to decline. In particular, when the tiers of an application run on dissimilar operating systems. This increased cost of ownership makes it expensive, for example, to leverage the I/O throughput, scalability and availability of a data server on z/OS with the wide support for open-source software for application servers running on Linux.

What is therefore needed is a system, a computer program product, and an associated method for performing an administrative task upon the occurrence of a triggering event, enabling an administrator to perform tasks associated with the data servers in the enterprise information tier via operating systems in the mid-tier or the client tier without requiring additional, specific knowledge on the part of the administrator. The need for such a solution has heretofore remained unsatisfied.

### SUMMARY OF THE INVENTION

The present invention satisfies this need, and presents a system, a service, a computer program product, and an associated method (collectively referred to herein as “the system” or “the present system”) for performing an administrative task upon the occurrence of a triggering event.

In response to the triggering event, the present system recognizes a need to perform an administrative task on one of a set of data servers. A user selects the administrative task after or before the triggering event occurs. The present system determines the operational status of the data server to determine a communication protocol for communicating with the data server, selects the communication protocol based on the operational status of the data server adding the selected administrative task to a task list, and executes the selected administrative task at a predetermined execution time or upon the occurrence of a triggering event without intervention by a human administrator.

### BRIEF DESCRIPTION OF THE DRAWINGS

The various features of the present invention and the manner of attaining them will be described in greater detail with reference to the following description, claims, and drawings, wherein reference numerals are reused, where appropriate, to indicate a correspondence between the referenced items, and wherein:

FIG. 1 is a schematic illustration of an exemplary operating environment in which a resilient administrative schedule system of the present invention can be used;

FIG. 2 is a diagram of a high-level hierarchy of a remote administrator of the resilient administrative schedule system of FIG. 1;

FIG. 3 is a diagram of a high-level hierarchy of an administrative scheduler of the resilient administrative schedule system of FIG. 1; and

FIG. 4 represents a process flow chart illustrating a method of operation of the resilient administrative schedule system of FIG. 1.

### DETAILED DESCRIPTION OF PREFERRED EMBODIMENTS

The following definitions and explanations provide background information pertaining to the technical field of the present invention, and are intended to facilitate the understanding of the present invention without limiting its scope:

Resilient: Remaining operational and functional in a group of coordinated servers as long as one of the servers remains operational.

Client Tier: a group of computers functioning as clients in a distributed computing system. Examples of clients in a client tier are computers connected to the Internet via a Web browser.

Mid-tier: a group of computers functioning as application servers in a distributed computing system. An example of a mid-tier is a Web application server accessed by the client via a Web browser.

Enterprise Information Tier: a group of computers such as mainframes acting as data servers for a database. An example of an enterprise information tier is a set of mainframe computers providing banking database access for clients accessing accounts via a Web browser and Web servers.

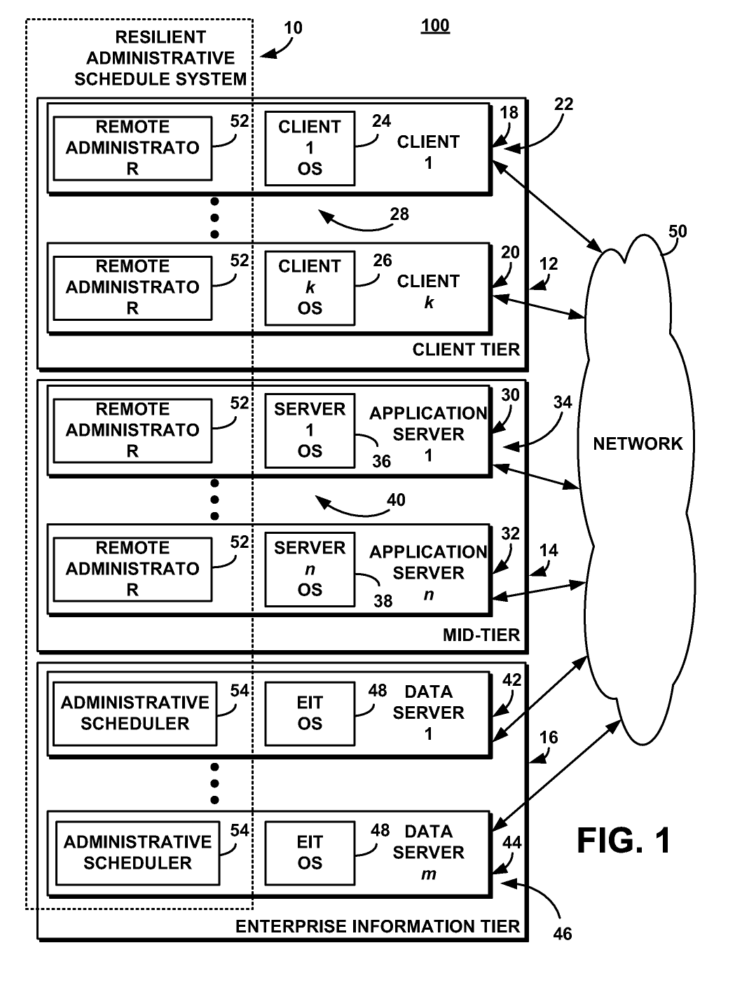

FIG. 1 portrays an exemplary high-level architecture of an enterprise information system 100 in which a system, a service, a computer program product, and an associated method (the resilient administrative schedule system 10 or the “system 10”) for performing an administrative task upon an occurrence of a triggering event according to the present invention may be used. System 10 comprises a software programming code or a computer program product that is typically embedded within, or installed on a computer. Alternatively, system 10 can be saved on a suitable storage medium such as a diskette, a CD, a hard drive, or like devices.

System 10 can take the form of an entirely hardware embodiment, an entirely software embodiment or an embodiment containing both hardware and software elements. In one embodiment, system 10 is implemented in software, which includes but is not limited to firmware, resident software, microcode, etc.

Furthermore, system 10 can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid-state memory, magnetic tape, a removable computer diskette, a random access memory (RAM), a read-only memory (ROM), a rigid magnetic disk, and an optical disk. Current examples of optical disks include compact disk-read only memory (CD-ROM), compact disk-read/write (CD-R/W) and DVD.

A data processing system suitable for storing and/or executing program code includes at least one processor coupled directly or indirectly to memory elements through a system bus. The memory elements can include local memory employed during actual execution of the program code, bulk storage, and cache memories that provide temporary storage of at least some program code to reduce the number of times code is retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modems, and Ethernet cards are just a few of the currently available types of network adapters.

The enterprise information system 100 comprises a client tier 12, a mid-tier 14, and an enterprise information tier 16. The client tier 12 comprises many instances of client computers such as a client 1, 18, through a client k, 20, collectively referenced as clients 22. Each of the clients 22 comprises a client operating system designated as a client 1 OS 24 through a client k OS 26, collectively referenced as client operating systems 28. The client operating systems 28 may be of similar type the same or may vary in type from one to the next of the clients 22.

The mid-tier 14 is a tier on which packaged or in-house developed applications operate. The mid-tier 14 comprises many instances of servers such as an application server 1, 30, through an application server n, 32, collectively referenced as application servers 34. Each of the application servers 34 comprises a server operating system such as a server 1 OS 36 through a server n OS 38, collectively referenced as server operating systems 40. The server operating systems 40 may vary in type from one to the next of the application servers 34 but are typically consistent among the application servers 34. The mid-tier 14 is optional; the client tier 12 may comprise client-server architecture and function without the mid-tier 14.

The enterprise information tier 16 is a tier on which data servers such as a data server 1, 42, through a data server m, 44 (collectively referenced as data servers 46) operate. The data servers 46 comprise databases accessed by the clients 22 via the application servers 34. The data servers 46 each comprise a data server operating system such as an enterprise information tier (EIT) OS 48 (interchangeably referenced herein as the data server operating system 48). The data server operating system 48 is typically a more complex operating system compared to the client or mid-tier operating systems requiring specific knowledge on the part of an administrator.

Clients 22, the application servers 34, and the data servers 46 communicate via a network 50. In one embodiment, network 50 is the Internet. While described in terms of a network such as the Internet, it should be clear that system 10 is applicable as well to, for example, systems that communicate via any type of network such as a wide area network, a local area network, etc. Furthermore, the clients 22, application servers 34, and the data servers 46 may be co-located or remotely located with respect to one another.

System 10 comprises a remote administrator 52 and an administrative scheduler 54. The remote administrator 52 is installed on any of the clients 22 and/or any of the application servers 34. System 10 enables all automated and non-automated preventative and corrective administrative tasks for data servers 46, including complex tasks such as system recovery and homogenous system copies that involve stopping and restarting the data servers 46 via a remote interface of the remote administrator 52. System 10 eliminates the need for an administrator to log on to the data servers 46. System 10 further removes the requirement for platform specific knowledge by an administrator to manage the operation of the data servers 46.

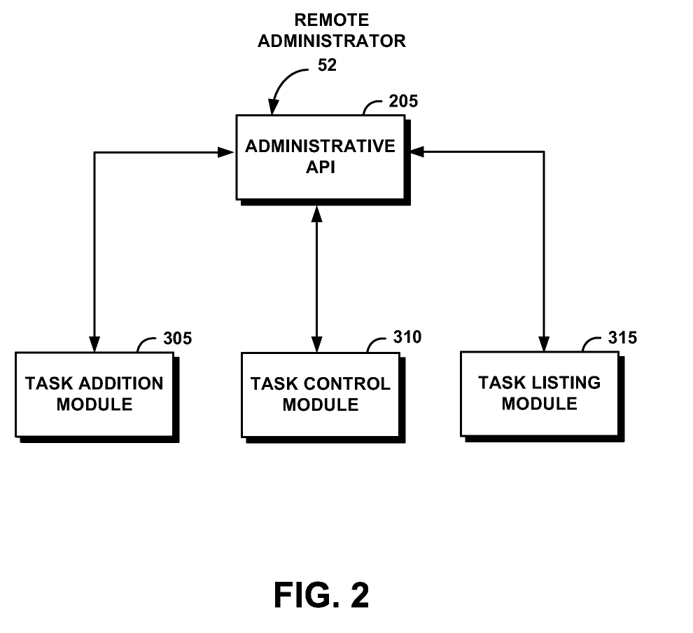

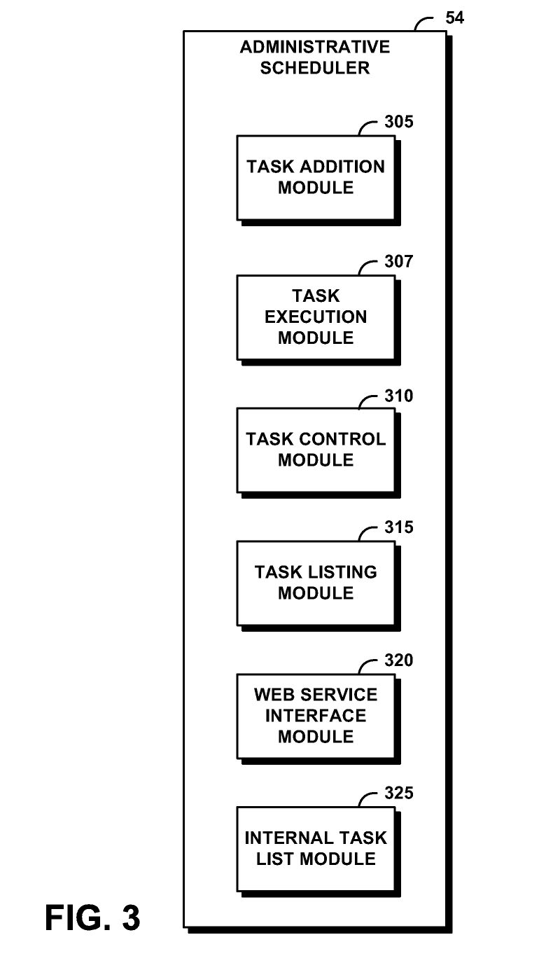

FIG. 2 illustrates a high-level hierarchy of the remote administrator 52. With further reference to FIG. 3, the remote administrator 52 accesses a task addition module 305, a task control module 310, and a task listing module 315, through an already established data server query language protocol or a Web services protocol. When it accesses the task modules through a Web services protocol, the Web service interface module comprises the endpoint interface and routes them to the corresponding task module.

FIG. 3 illustrates a high-level hierarchy of the remote administrator 52. The administrative scheduler 54 comprises a task addition module 305, a task control module 310, a task listing module 315, a Web service interface module 320, and an internal task list module 325.

The remote administrator 52 uses the task addition module 305 to add a task to the administrative scheduler 54. Parameters of the task addition module 350 comprise the following: start and end timestamp, scheduling parameters, task parameters, and optionally security parameters. The start and end parameters define a start and end time for when the task will be considered for scheduling. The scheduling parameters comprise an execution interval, execution point in times, a triggering event that is triggered by the associated data server or by the completion of a previous task under certain exit conditions, and an optional, maximum number of invocations. Task parameters comprise a stored procedure name and a query statement for the input parameters, operating system specific script information (such as for Job Control Language on z/OS or a shell script on UNIX). Notification methods which may comprise email, page, and short message service (SMS) notification that can be added as triggered tasks. Security parameters are used if an associated task requires a special security context to run.

The remote administrator 52 uses the task control module 310 to control a task that has been added to the administrative scheduler 54. The task control module 310 can suspend or remove one or more tasks. The remote administrator 52 uses the task listing module 315 to list one or more tasks that have been added to the administrative scheduler 54. The Web service interface module 320 exposes service interface methods for the task modules 305, 310, and 315.

The internal task list module 325 comprises a task list in a task list file that can be accessed by each administrative scheduler 54 in a shared data server architecture, where the data servers 46 share the same database but run on different servers for improved availability. A second active copy of the task list file is used for redundancy and protection against disk media failure in particular. Any administrative scheduler 54 that first evaluates that a task requires execution executes the task and records the start timestamp in the task list to implement simple first-come-first-served scheduling so that a task is not executed twice by two cooperating administrative schedulers 54.

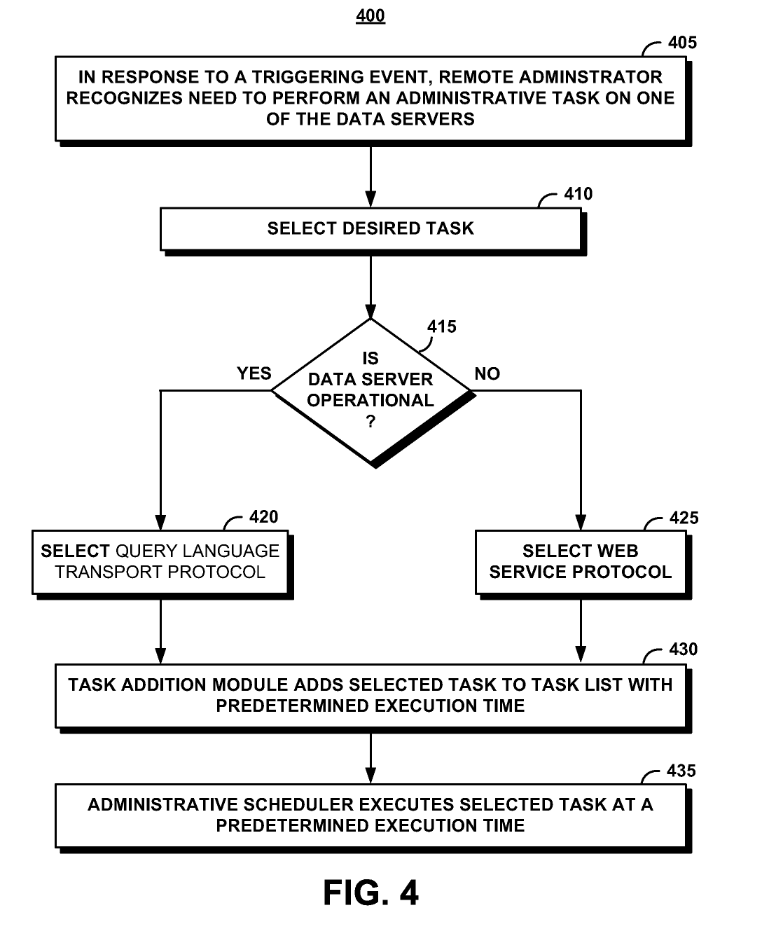

FIG. 4 illustrates a method 400 of system 10 in remotely performing administrative tasks on one of the data servers 46 on the enterprise information tier 16. In response to a triggering event, the remote administrator 52 on any of the clients 22 or the application servers 34 recognizes a need to perform an administrative task on one of the data servers 46; e.g., the data server 1, 42 (step 405). Administrative tasks may comprise any of security and auditing, operation and recovery, performance monitoring and tuning, problem determination, change management. The user or human administrator, or the autonomic or automated software functions, via the remote administrator 52 interface, initiate the desired administrative task (step 410).

The remote administrator 52 determines whether the data server 1, 42, is operational to determine a communication protocol for communicating with the administrative scheduler 54 (decision step 415). If yes, the remote administrator 52 selects a query language protocol (step 420) for communicating with the administrative scheduler 54 on the data server 1, 42 and accesses the task modules using query language. In one embodiment, the query language is structured query language, SQL, and the query language protocol is DRDA. If no, the remote administrator 54 selects a Web service protocol for communicating with the administrative scheduler 54 on the data server 1, 42, via the Web service interface module 320. In one embodiment, the Web service protocol is Simple Object Access Protocol (SOAP) over HTTP.

The task addition module 305 adds the selected administrative task to the task list (step 430) with a predetermined execution time or execution start event. A task execution module 307 executes the selected task at the predetermined execution time (step 435) or when the execution start event occurs. System 10 enables a user to perform administrative tasks on any of the data servers 46 on the enterprise information tier 16 without requiring the user to be trained as an administrator of the EIT OS 48 of the data servers 46.

The administrative scheduler 54 reads the task list file at random points in time within a pre-determined, short interval with a maximum and checks for updates. If an update exists, the administrative scheduler 54 reads the updates. The internal task list module serializes access to the shared task list file from concurrently accessing administrative schedulers. If a task is to be executed, the task execution module 307 executes the task asynchronously in a secondary thread of execution. If a task expires, the administrative scheduler 54 removes the entry from the task table after a predefined time or using a predefined criteria so that there are no metadata housekeeping requirements.

System 10 provides resilient administration for the enterprise information tier 16. System 10 is resilient in that the administrative scheduler 54 does not stop operating if its associated data servers 46 in the enterprise information tier 16 stop operating. System 10 provides built-in redundancy. As long as any of the administrative schedulers 54 is operational, system 10 is operational.

In an enterprise information tier 16, the administrative scheduler 54 is a separate process. If, for example, a database on the data server 1, 42, fails or is stopped, the administrative scheduler 54 continues to function to provide restart functionality for a business resilient enterprise information tier. The administrative scheduler is started automatically by its associated data server so that the scheduler does not have to be started by an administrator logging on to the EIT OS and requires no additional administrative tasks on the EIT OS.

It is to be understood that the specific embodiments of the invention that have been described are merely illustrative of certain applications of the principle of the present invention. Numerous modifications may be made to the system and method for automatically performing an administrative task upon the occurrence of a triggering event described herein without departing from the spirit and scope of the present invention. Moreover, while the present invention is described for illustration purpose only in relation to an enterprise information system, it should be clear that the invention is applicable as well to, for example, to any system in which dissimilar operating systems are used.

What is claimed is:

1. A processor-implemented method of automatically performing an administrative task upon the occurrence of a triggering event, the method comprising:
recognizing a need to perform an administrative task a data server, in response to the triggering event;
determining an operational status of the data server in order to determine a communication protocol for communicating with the data server;
selecting the communication protocol based on the operational status of the data server;
adding the selected administrative task to a task list; and
executing the selected administrative task at the occurrence of any of a predetermined execution time or a predetermined event.

2. The method of claim 1, wherein the communication protocol includes a query language protocol.

3. The method of claim 2, wherein the querying language includes a structured query language, SQL.

4. The method of claim 1, wherein the communication protocol includes a Web service protocol.

5. The method of claim 4, wherein the Web service protocol includes Simple Object Access Protocol, SOAP, over HTTP.

6. The method of claim 4, wherein the Web service protocol includes a Web Services Interoperability Organization, WS-I, compliant Web service protocol.

7. The method of claim 4, wherein the Web service protocol includes a Web Services Interoperability Organization, WS-I, non-compliant Web service protocol.

8. The method of claim 1, wherein the triggering event includes a scheduling of a task by any one or more of a remote administrator, a data server lifecycle event, and the completion of a preceding task.

9. The method of claim 1, further comprising selecting the administrative task.

10. The method of claim 9, wherein selecting the administrative task is performed manually.

11. A processor-implemented system for automatically performing an administrative task upon the occurrence of a triggering event, the system comprising:
a remote administrator for recognizing a need to perform an administrative task a data server, in response to the triggering event;
the remote administrator determining an operational status of the data server in order to determine a communication protocol for communicating with the data server;
the remote administrator selecting the communication protocol based on the operational status of the data server;
a task addition module of an administrative scheduler for adding the selected administrative task to a task list; and
the administrative scheduler for executing the selected administrative task at the occurrence of any of a predetermined execution time or a predetermined event.

12. The system of claim 11, wherein the communication protocol includes a query language protocol.

13. The system of claim 12, wherein the querying language includes a structured query language, SQL.

14. The system of claim 11, wherein the communication protocol includes a Web service protocol.

15. The system of claim 14, wherein the Web service protocol includes Simple Object Access Protocol, SOAP, over HTTP.

16. A computer-program product having executable codes stored on a computer-usable medium for automatically performing an administrative task upon the occurrence of a triggering event, the computer program product comprising:
a program code for recognizing a need to perform an administrative task a data server, in response to the triggering event;
a program code for determining an operational status of the data server in order to determine a communication protocol for communicating with the data server;
a program code for selecting the communication protocol based on the operational status of the data server;
a program code for adding the selected administrative task to a task list; and
a program code for executing the selected administrative task at the occurrence of any of a predetermined execution time or a predetermined event.

17. The computer program product of claim 16, wherein the communication protocol includes a query language protocol.

18. The computer program product of claim 17, wherein the querying language includes a structured query language, SQL.

19. The computer program product of claim 16, wherein the communication protocol includes a Web service protocol.

20. The computer program product of claim 19, wherein the Web service protocol includes Simple Object Access Protocol, SOAP, over HTTP.
